(19) United States
(12) Patent Application Publication
(10) Pub. No.: US 2014/0085218 A1
(43) Pub. Date: Mar. 27, 2014

(54) CHILD'S WEARABLE COMPUTING DEVICE

(71) Applicant: FRANKLIN ELECTRONIC PUBLISHERS, INCORPORATED, (US)

(72) Inventor: Pang Lee, Tseung Kwan O (HK)

(73) Assignee: FRANKLIN ELECTRONIC PUBLISHERS, INCORPORATED, Burlington, NJ (US)

(21) Appl. No.: 13/628,570

(22) Filed: Sep. 27, 2012

(51) Int. Cl. G06F 3/041

(52) U.S. Cl. 345/173

(57) ABSTRACT

A wearable digital media device comprising an integrated circuit configured to send and receive content on receipt of a serial identification number unique to the personal digital media device, a processor and a display screen. The personal digital media device's processor utilizes a radio frequency integrated circuit to send and receive content with, for example, a personal computer or other host processing device. The personal digital media device is configured and outfitted to be worn by the user, for example, as a watch, a pendent, or attached to a user's book bag.

### FIELD OF THE INVENTION

The present invention relates in general to personal digital media devices and in particular a wearable digital media device that wirelessly interfaces with a computer or other host processing device, such as a tablet or smart phone, in order to send and receive content to and from the host processing device. The invention further relates to a method of providing application programs and content applicable mainly to the teaching of spelling, math and other academic skill to students with a wearable digital media device paired directly to a personal computer or other host processing device.

### BACKGROUND OF THE INVENTION

Various personal digital media devices are available for a variety of applications and uses. There exists a need in the art to provide learning content to a student in a manner that permits a supervisor, such as a teacher or a parent to assign, customize, and track the student's mastery of a given topic, such as spelling or mathematics. Often, the known devices ask questions in an audible format or display partially displayed words and prompt a student to supply the missing letters. Alternatively, the known devices may, for example, prompt a student to supply the sum, product, or quotient of a given mathematical expression.

Several devices are known in the art to address this need, yet often, the known media devices have limitations that make it difficult for adult supervisors to properly track a student's progress through the learning content and lack the computing power to handle more processor-intensive calculations, such as speech recognition. Other personal digital media devices may become easily lost by children. A need exists in the art to develop a wearable digital media device that will make the device less likely to be lost by a youthful user, so that such device is incorporated into a wearable article, such as a watch, pendant, or keychain, or incorporated into cloth or book bags.

A further need exists in the art to accommodate a plurality of personal digital media devices in circumstances in which a supervisor desires to assign and monitor a plurality of students, each student using their own personal digital media device. Ideally, a supervisor would be able to monitor one or more students in a real-time environment from a personal computer in dynamic communication with one or more wearable media devices. Thus, it is with respect to these considerations and others that the present device has been invented.

### SUMMARY OF THE INVENTION

According to the present invention, the foregoing and other objects and advantages are obtained by utilizing a wearable digital media device with an integrated circuit that is configured to send and receive digital signals with a host processing device upon the host processing device's receipt of a serial identification number unique to the digital media device which is transmitted by digital signals from the digital media device to the host processing device. The wearable digital media device includes a processor that performs actions, including: (1) using the integrated circuit to send and receive digital signals; (2) using the integrated circuit to send and receive the serial identification number unique to the digital media device; and (3) a display screen adapted to display graphical and alphanumeric content and utilizing an SRS touch panel for receiving input from a user of the device. The wearable digital media device also includes a microphone, a headphone jack, at least one control button, a micro USB connection, a speaker, a motion sensor, and an attaching fastener.

In another aspect of the invention, the wearable digital media device's motion sensor comprises a magnetometer and an accelerometer. In another aspect of the invention, the wearable digital media device's integrated circuit is a radio frequency integrated circuit. In another aspect of the invention, the host processing device includes, for example, a personal computer, a tablet computer, or a smart phone.

In another aspect of the invention, the wearable digital media device's signals comprise content, such as learning content or data sent from application software operating on a host processing device.

In another aspect of the invention, the wearable digital media device's attaching fastener attaches the wearable digital media device to, for example, a watch band, a pendant, a bookmark, a keychain, or a book bag.

In another aspect of the invention, the wearable digital media device also includes the processor being further adapted to receive data from a host processing device transmitted in the form of digital signals to the wearable digital media device via the integrated circuit in the wearable digital media device to signal the broadcast of an audible signal with the speaker. According to another aspect of the invention, the integrated circuit is a radio frequency integrated circuit or a BLUETOOTH transmitter integrated circuit. According to another aspect of the invention, the wearable digital media device content comprises mathematical questions and answers. According to another aspect of the invention, the wearable digital media device's content comprises spelling questions and answers, general knowledge questions and answers, or logical operations questions and answers. According to another aspect of the invention, the wearable digital media device content comprises a plurality of possible selections of which the user of the wearable digital media device may select one of the possible selections which is subsequently sent and received as content. According to another aspect of the invention, a system for communication between a host processing device and a personal digital media device, includes a host processing device that is configured and programmed to perform actions including: (1) a radio frequency integrated circuit that is configured to send and receive digital signals encoding content with a personal digital media device and (2) a database file and file system to store and recognize a unique serial identification number corresponding to a wearable digital media device where a unique serial identification number is transmitted as digital signals by the wearable digital media device by radio frequency, where the wearable digital media device comprises (a) a radio frequency integrated circuit that is configured to send and receive digital signals encoding content with a host processing device; (b) a unique serial identification number; and (c) an attaching fastener.

According to another aspect of the invention, the host processing device is a personal computer, tablet computer or smart phone.

According to another aspect of the invention, there is a system for communication between a host processing device and a personal digital media device, comprising: (1) a host processing device that is configured and programmed to perform actions including: (a) a radio frequency integrated circuit that is configured to send and receive digital signals encoding content with a personal digital media device; (b) a display screen; (c) a database file and file system to store and recognize a unique serial identification number corresponding to a wearable digital media device where a unique serial identification number is transmitted as digital signals by the wearable digital media device by radio frequency; and (2) the wearable digital media device comprises: (i) a radio frequency integrated circuit that is configured to send and receive digital signals encoding content with a host processing device; (ii) a unique serial identification number; (iii) a touch screen display; (iv) a remote control functional mode that displays the content of the touch screen display on the display screen of the host processing device; and (v) an attaching fastener.

According to another aspect of the invention, the host processing device is a personal computer, tablet computer or smart phone.

### BRIEF DESCRIPTION OF THE DRAWINGS

The invention will become more readily apparent from the following description of preferred embodiments thereof shown, by way of example only, in the accompanying drawings wherein:

FIG. 1 shows a schematic diagram of one embodiment of a wearable digital media device that may be employed;

FIG. 2 shows a functional diagram illustrating an environment for practicing the invention;

FIG. 3 shows a perspective view of one embodiment of the wearable digital media device;

FIG. 4 shows a perspective view of one embodiment of the wearable digital media device;

FIG. 5 shows a perspective view of one embodiment of the wearable digital media device;

FIG. 6 shows a perspective view of one embodiment of the wearable digital media device;

FIG. 7 shows a perspective view of one embodiment of the wearable digital media device;

FIG. 8 shows a perspective view of one embodiment of the wearable digital media device;

FIG. 9 shows a perspective view of one embodiment of the wearable digital media device;

FIG. 10 shows a perspective view of one embodiment of the wearable digital media device;

FIG. 11 is flow chart illustrating a method for carrying out one embodiment of the invention.

FIG. 12 is flow chart illustrating a method for carrying out another embodiment of the invention.

### DETAILED DESCRIPTION OF THE INVENTION

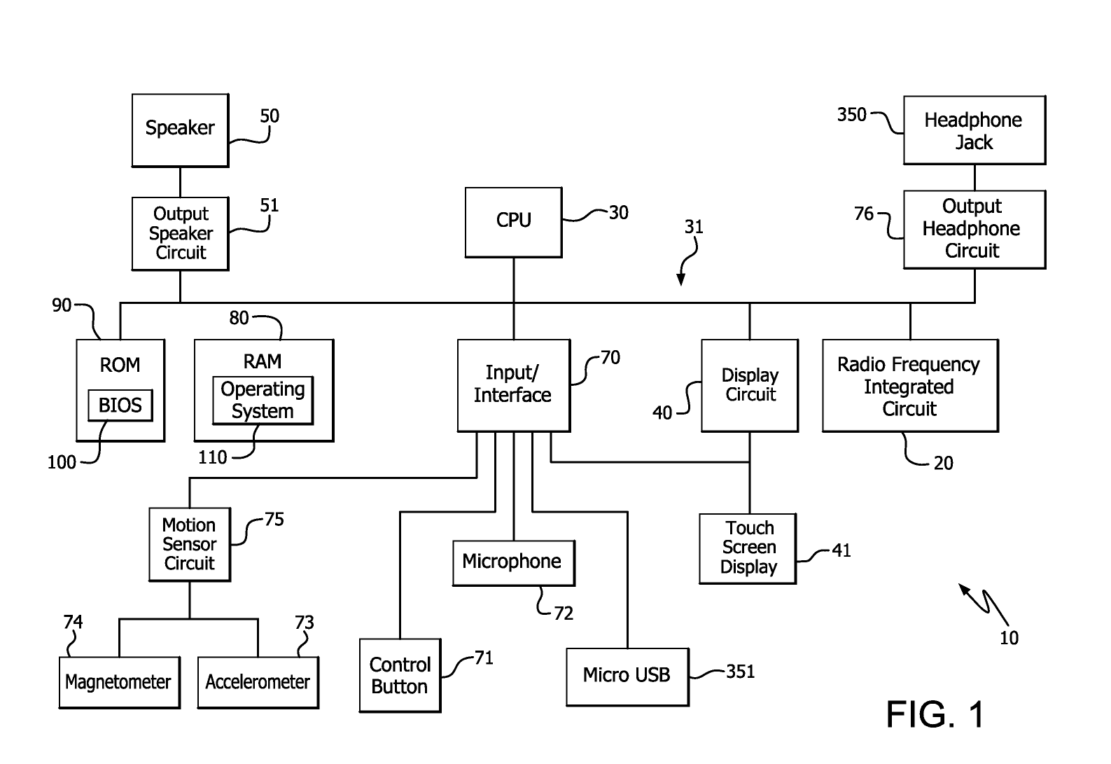

Referring to the drawings wherein like or similar references indicate like or similar elements throughout the several views, there is shown in FIG. 1 a schematic diagram of one embodiment of a wearable digital media device that may be employed, generally identified by reference numeral 10. Central Processing Unit 30 (“CPU”) operates as the main control unit for the personal digital media device. The CPU 30 can be any microprocessor that is capable of being programmed to perform the various functions required by the personal digital media device. In a preferred embodiment, CPU 30 is a microcontroller unit with integrated RAM, ROM and input/output code and circuitry configured to perform the functions herein described. CPU 30 is programmed with the driver software necessary to control and enable each of the circuits connected to CPU 30. In addition, CPU 30 is programmed with application software to allow the user to perform functions on the database stored in the device. CPU 30 is electrically connected to and controls the other circuits in the wearable digital media device via bus 31.

Output headphone circuit 76 is electronically connected to CPU 30. Output headphone circuit controls headphone jack 350 and permits connected headphones (not depicted) to receive audio output content.

Display circuit 40 is electrically connected to CPU 30. The display circuit 40 controls the touch screen display 41 used to provide information to the wearable digital media device user. The touch screen display 41 can display graphical content and also incorporates an SRS touch panel for receiving input from a user. Speaker 50 is electrically connected to CPU 30 via output speaker circuit 51. Speaker 50 creates an audible sound according to one embodiment of this invention, as further explained herein. Input interface circuit 70 is electrically connected to CPU 30, microphone 72, control button 71, display screen 41, and motion sensor circuit 75, which comprises magnetometer 74 and accelerometer 73. The input interface circuit 70 receives data input from the wearable digital media device user though microphone 72, control button 71, display screen 41, motion sensor circuit 75, magnetometer 74, micro USB 351, and/or accelerometer 73 and, in turn, conveys certain data input to CPU 30. In other embodiments, there are more than one control button 71 (not depicted). In another embodiment, input interface 70 can receive sound information, such as a digital media device user's voice, through a microphone 72.

Radio frequency integrated circuit 20 is electrically connected to CPU 30. The radio frequency integrated circuit 20 facilitates wireless communication between the wearable digital media device and another device, such as a personal computer, tablet computer, smart phone, or other host processing device, with its own radio frequency integrated circuit, each adapted to send and receive radio frequency transmissions from one another. The radio frequency integrated circuit 20 can be utilized to send and receive data, including, for example, data corresponding to a serial identification number unique to the wearable digital media device. In a preferred embodiment, the radio frequency integrated circuit 20 is of the type typically used by those having ordinary skill in the art for the purposes described herein, including: (1) an integrated CMOS RF receiver, combined with a dual 64-byte buffered framer block; (2) a self-contained, fast-hopping FSK data modem, optimized for use in the widely available 2.4 GHz ISM band; and (3) contains a frequency synthesizer, a power amplifier, a 12 MHz crystal oscillator, a demodulator, a modulator and an auto-Ack protocol engine; however, other radio frequency technology known to those having ordinary skill in the art, such as Bluetooth or Wi-Fi may be utilized as well.

The wearable digital media device incorporates mass memory. The mass memory includes RAM 80 and ROM 90. In one embodiment, ROM 90 is flash memory that includes content BIOS, operating system program, and application programs stored in memory. RAM 80 is used for run time memory. In a preferred embodiment, the wearable digital media device incorporates mass memory in CPU 30. In one embodiment, hard disk drives and other more permanent storage devices are not utilized since those devices would increase the cost of the wearable digital media device and such storage within the wearable digital media device is otherwise unnecessary in view of the instant invention's utilization of a personal computer or other host processing device (such as a smart phone or other device programmed and configured to perform the functions of a personal computer herein described) to store certain information, as further explained herein. In one embodiment, RAM 80 is sufficient to store operating system 110 to control the operation of the personal digital media device. Any general-purpose operating system may be employed with a basic input/output system (“BIOS”) 100 for controlling the low-level operation of the personal digital media device. In one embodiment, operating system 110 and BIOS 100 is incorporated into CPU 30.

In other embodiments, the mass memory described above may incorporate computer-readable media, such as computer storage media commonly recognized by those having ordinary skill in the art, such as flash memory or any other medium which can be used to store the described information and can be accessed by the personal digital media device. The mass memory stores program code and data. Applications are loaded into the mass memory and run on operating system 110. Such applications may include user interface programs interfacing with database programs and the like. The mass memory is further configured to store information related to a serial identification number unique to the personal digital media device.

In one embodiment of the present invention, application software may include a graphical user interface prompting the wearable digital media device user to complete the missing letters of a partially spelled word. In another embodiment of the present invention, application software may include a graphical user interface prompting the wearable digital media device user to supply the sum, product, quotient, missing value, or other input in response to a mathematical question. The wearable digital media device user's input will be stored in the personal digital media device's mass memory within a database for subsequent use and access in accord with the invention further described herein. In another embodiment of the present invention, application software may include a graphical user interface prompting the wearable digital media device user to supply one of a series of possible displayed selections. This may be commonly recognized as a multiple-choice question. In the case of the spelling, mathematical, general knowledge, logical operations, or multiple-choice application embodiments herein described, the wearable digital media device user's selections can be stored in the mass memory of the wearable digital media device and/or sent via radio frequency to another device, such as a personal computer or other host processing device. Additionally, the other device, such as a personal computer, may utilize radio frequency transmissions to send subsequent application questions or other content to the wearable digital media device user through the use of digital signals. In a preferred embodiment, the connection between the wearable digital media device and the other device can be utilized along with application software on the other device programmed and configured to: (i) prepare reports summarizing a digital media device user's mastery of the learning content which may be, for example, sent to a parent via e-mail or accessed on the host processing device or through any browser connected device, such as another personal computer (other than the host processing device), a tablet personal computer, or a smart phone; (ii) permit a supervisor, such as a teacher or parent, to use the other device to monitor the wearable digital media device user's progress through the learning content at any time; (iii) send text or audio messages from the other device to the personal digital media device; (iv) adjust the wearable digital media device settings using the other device; and (v) add, delete or modify the learning content sent from the other device to the personal digital media device.

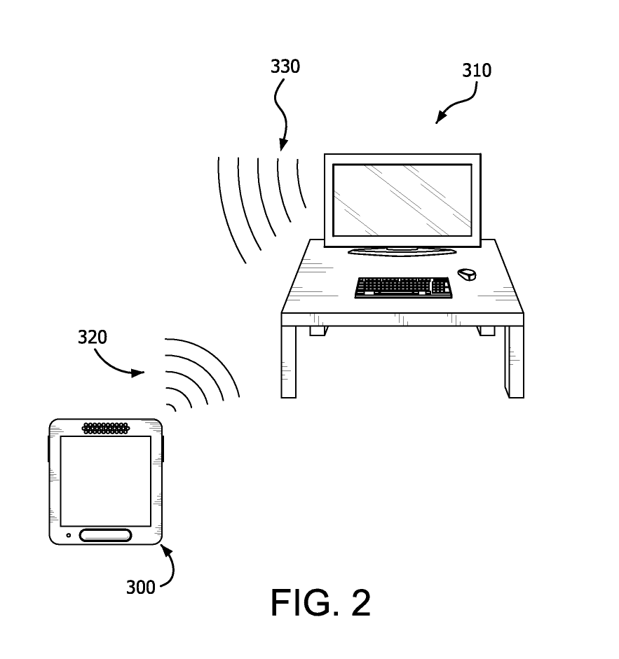

FIG. 2 shows a functional block diagram illustrating an environment for practicing the invention via a system for communication by and among a personal computer 310 and a wearable digital media device 300 according to one embodiment of the instant invention. While this embodiment exemplifies the use of a personal computer, any host processing device, such as a smart phone or other device programmed and configured to perform the functions herein ascribed to a personal computer, can be utilized. In this embodiment of the instant invention, a personal computer 310 is configured to perform actions which include the use of a radio frequency integrated circuit that is configured to send and receive content through the use of digital signals with a wearable digital media device 300, as shown by radio frequency transmission 330. Personal computer 310 contains a database file and file system within its mass storage to store and recognize a unique serial identification number corresponding to a wearable digital media device 300 where the unique serial identification number is transmitted by the wearable digital media device 300 by radio frequency transmission of digital signals, as shown by radio frequency transmission 320. The wearable digital media device 300 is also configured with a radio frequency integrated circuit (also referred to as a transmission signal module) that is configured to send and receive content with the personal computer 310 in the form of digital signals. The wearable digital media device 300 is programmed with a unique serial identification number.

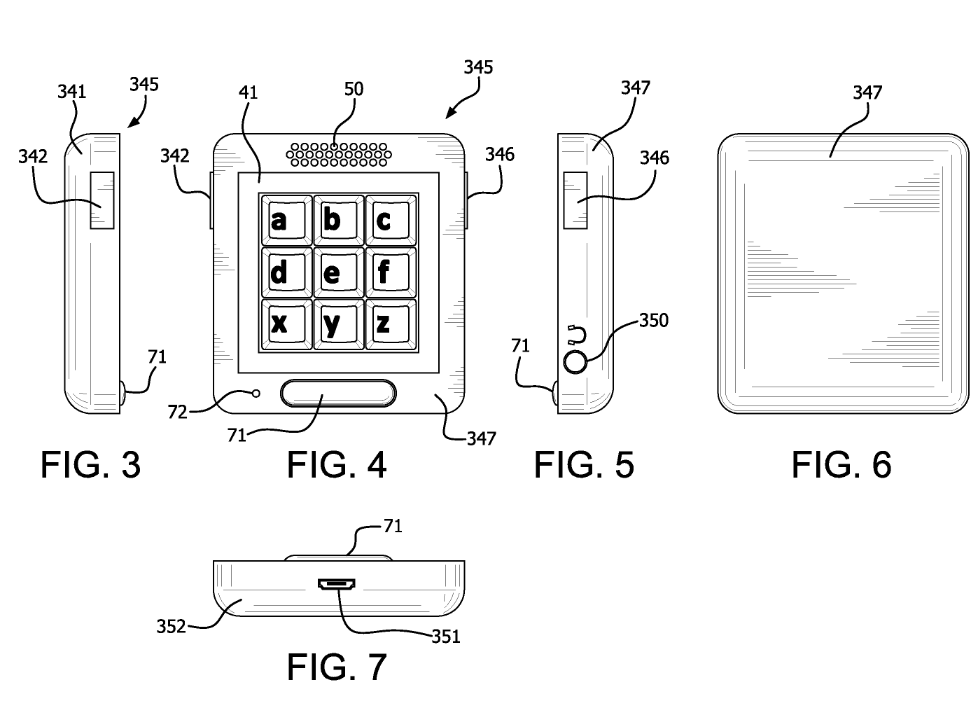

FIGS. 3 through 7 exemplify one embodiment of the instant invention. In FIG. 3, the wearable digital media device is generally identified by reference numeral 345. Wearable digital media device 345 is depicted in FIG. 3 from the left side 341. Left side 341 has first custom button 342. In FIG. 4, wearable digital media device 345 is depicted from the front side, facing screen 41. FIG. 4 depicts front side 347 with speaker 50, control button 71, microphone 72, first custom button 342 and second custom button 346. Both first custom button 342 and second custom button 346 are additional input mechanisms that are, in this embodiment, electronically connected to the input interface 70 depicted in FIG. 1 (not depicted). FIG. 5 depicts right side 347 with headphone jack 350. FIG. 6 depicts rear side 348. FIG. 7 depicts bottom side 352, showing Micro USB Port Connection 351 and control button 71.

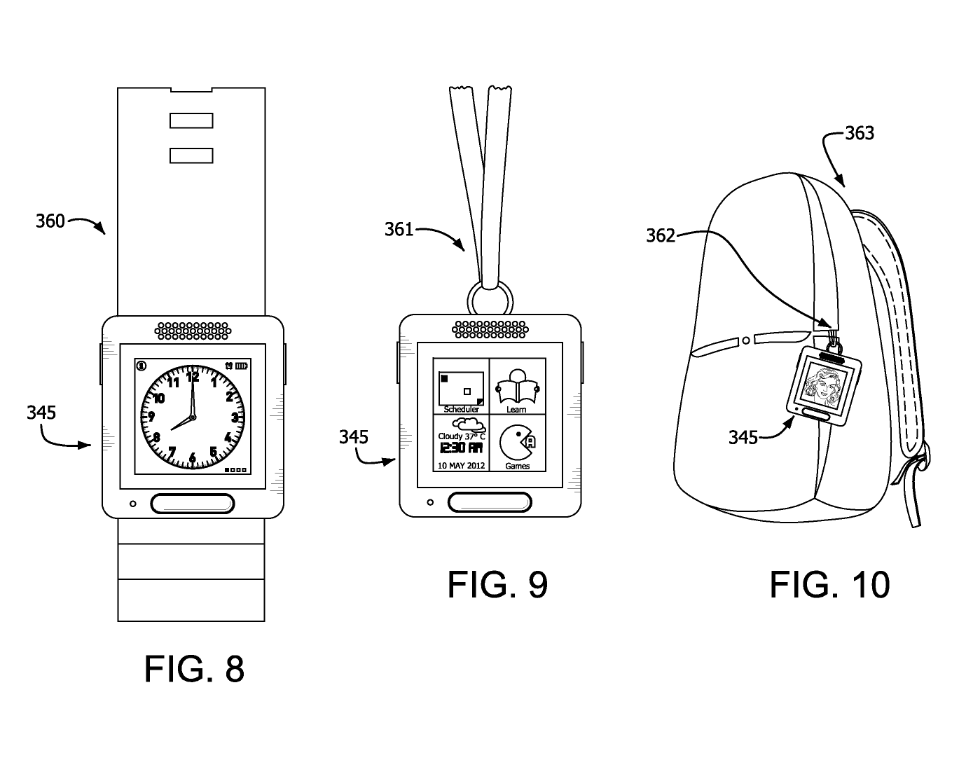

FIGS. 8 through 10 depict wearable digital media device 345 connected to various attached articles by way of an attaching fastener. In FIG. 8, wearable digital media device 345 is attached to a watch 360. In FIG. 9, wearable digital media device 345 is attached to pendant 361. In FIG. 10, wearable digital media device 345 is attached to keychain 362. Keychain 362 is attached to book bag 363.

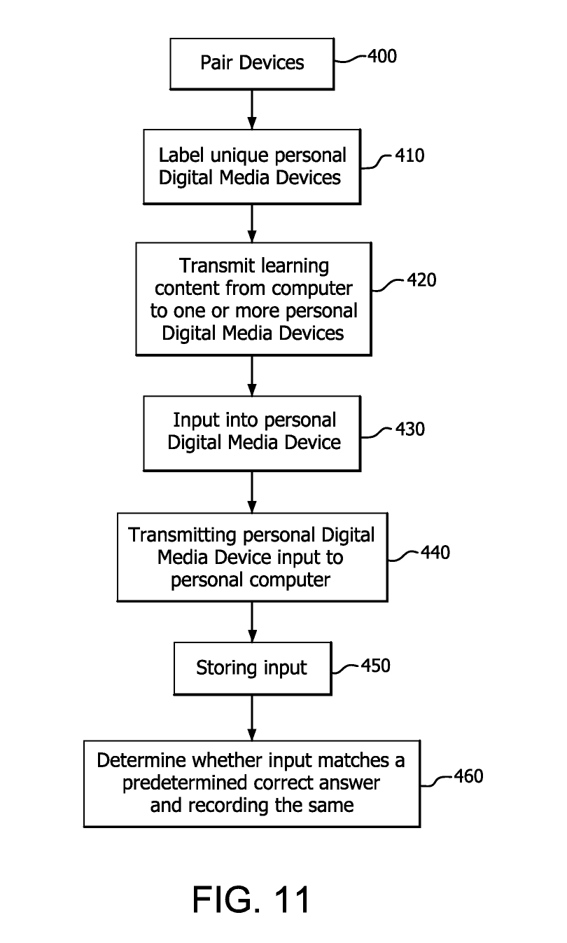

FIG. 11 is flow chart illustrating one embodiment of a system for carrying out one embodiment of the invention. According to this embodiment of the instant invention, a wearable digital media device and a personal computer are paired in step 400 by sending and receiving content with radio frequency integrated circuits incorporated in the wearable digital media device and a personal computer. The content is transmitted in the form of digital signals. While this embodiment exemplifies the use of a personal computer, any host processing device, such as a smart phone or other device programmed and configured to perform the functions herein ascribed to a personal computer can be utilized. The paring step 400 is completed after a processor in the personal computer is adapted to recognize the unique serial number associated with the personal digital media device. Accordingly, a plurality of personal digital media devices, each with their own unique serial number, can be independently paired with a personal computer.

Once the devices are paired, the personal computer user can label the paired wearable digital media device (or devices) with a user-selected name in step 410. A personal computer user may, for example, desire to designate a user-selected name as a way to identify which wearable digital media device may correspond to which wearable digital media device user. By way of a more specific example, a parent with two children using personal digital media devices may label each device in step 410 with the name of the child utilizing each respective device. In an alternative embodiment, step 410 is not utilized.

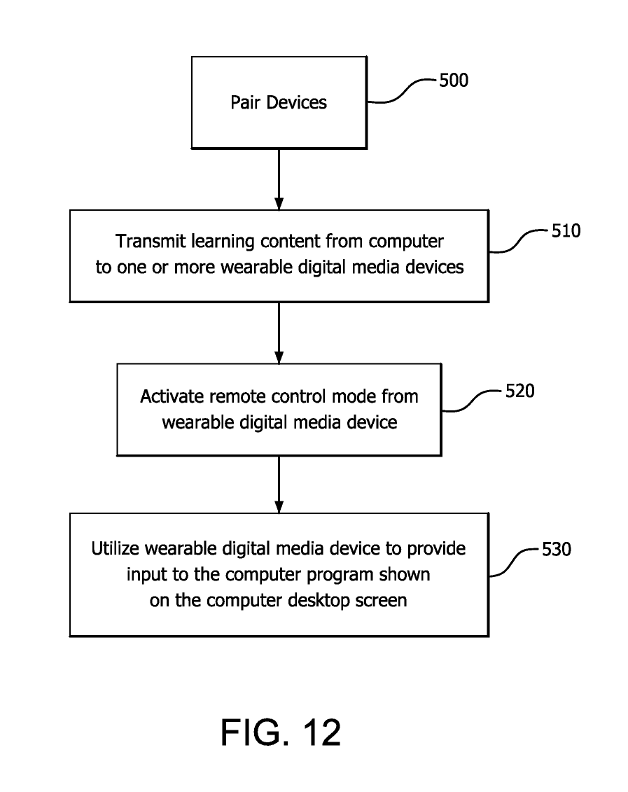

Content, such as learning applications with spelling questions, mathematical questions, general knowledge questions or logical operations questions, as well as other data, including, scheduling data, voice messages and text messages, are transmitted in the form of digital signals from a personal computer to each paired wearable digital media device with radio frequency integrated circuits incorporated in each paired wearable digital media device and the personal computer at step 420. This connection is illustrated by FIG. 12. At step 500, the wearable digital media device is paired to a computer, which may be a personal computer, smart phone or tablet computer, for example. At step 510, content, such as learning applications, is transmitted from the computer to one or more wearable digital media devices. At step 520, the remote control mode can be activated from the menu of the wearable digital media device. At step 530, a user may utilize the wearable digital media device to provide input to the computer program shown on the computer desktop screen.

Returning to FIG. 11, in step 430, the paired wearable digital media device user is provided with content, such as learning applications, displayed on the paired wearable digital media device screen and/or broadcast through the personal digital media device's speaker and the wearable digital media device user is prompted to input a response to the learning content.

In an alternative embodiment, the content, such as learning applications, is displayed on the screen of a paired personal computer, tablet computer, or smart phone using the means of data sharing herein disclosed. In this alternative embodiment, the wearable digital media device content can be displayed on, typically, a larger screen. As a consequence of this alternative embodiment, a user can operate the wearable digital media device and simultaneously view the content on the wearable digital media device touch screen display on the screen of another paired device.

In step 440, the paired wearable digital media device user's input in response to content, such as learning applications, is transmitted as digital signals to a paired personal computer via radio frequency integrated circuits incorporated in the paired wearable digital media device and the computer.

At step 450, the paired wearable digital media device user's input is stored in a database file and file system within the mass memory of the wearable digital media storage device. Additionally, or in the alternative, the digital media device user's input is stored in a database file and file system within the mass memory of the personal computer. In a preferred embodiment, the said input is stored exclusively on the wearable digital media storage device mass memory in order to operate the wearable digital media device independently of a host computer.

At step 460, a programmed personal computer and a processor adapted to the programmed personal computer's memory is used to compare the stored wearable digital media device user's input to a pre-determined correct input pursuant to a programmed application and storing information with respect to whether or not the user's input matches the correct input for the respective prompt in a database file and file system. In a preferred embodiment, step 460 is performed by the wearable digital media device, independently of the programmed personal computer.

By way of example, an application operating on a personal computer (or, in the preferred embodiment, the wearable digital media device) can contain learning content, such as a bank of questions appropriate to spelling, mathematical or other subjects. The question bank can be categorized by increasing levels of complexity. Questions can be sent according to the method herein described in step 420 from the personal computer to the personal digital media device (or, in a preferred embodiment, the questions already reside within the memory of the wearable digital media device and are merely recalled by the operating system). The wearable digital media device user can respond to the transmitted spelling question, math question or multiple choice question, for example, in step 430. The wearable digital media device user's input response can be transmitted back to the personal computer in step 440 through the use of a digital signal and then stored in the mass memory of the personal computer in step 450 (though, in other embodiments, it may also be optionally stored in the personal digital media device's mass memory). Based on the comparison performed in step 460, a wearable digital media device user's response would be recorded in the personal computer's mass memory as either correct or incorrect (or, in the preferred embodiment, the recording would be made within the mass memory of the wearable digital media device). If the response is incorrect, the question can be flagged in the personal computer's mass memory (or, in the preferred embodiment, the question is flagged in the wearable digital media device's mass memory and optionally sent to the personal computer's mass memory with the process herein described). A parent operating the personal computer, for example, can see which questions the student has supplied correct answers for and which questions were incorrect. Questions with incorrect answers can be transmitted to the wearable digital media device user for one or more subsequent attempts. In other embodiments, the application software will iterate to increasingly difficult categories of questions based on the student's mastery of less difficult material. In other embodiments, questions are not categorized, but instead offered at random or by some other ordering.

By way of a further example, the system herein described can be utilized by a teacher in a classroom environment. Each student can utilize his or her own personal digital media device. The teacher may quiz students by inputting pre-determined or teacher-created questions into a personal computer which can be sent to the students according to the system described herein and depicted in FIG. 3. Alternatively, according to another embodiment, students may send a signal using the personal digital media device, which would be received at a teacher's personal computer in a manner that utilizes the device labels herein described in order to identify which of a plurality of wearable digital media device users sent the said signal as an alternative to the student raising his or her hand to attract the teacher's attention.

In another embodiment, the digital signal transmitted to the wearable digital media device from a personal computer can signal a command to broadcast an audible sound (also referred to as an audible signal) from a speaker by way of a processor in the wearable digital media device being further adapted to receive such data and broadcast such sound. In yet another embodiment, the speaker is used to broadcast the audible form of the learning content transmitted to the wearable digital media device in addition to or as an alternative to displaying the learning content on the wearable digital media device screen.

1. A wearable digital media device comprising:
an integrated circuit that is configured to send and receive digital signals with a host processing device upon the host processing device's receipt of a serial identification number unique to the digital media device which is transmitted by digital signals from the digital media device to the host processing device;
a processor that performs actions, including:
using the integrated circuit to send and receive digital signals;
using the integrated circuit to send and receive the serial identification number unique to the digital media device; and
a display screen adapted to display graphical and alphanumeric content and utilizing an SRS touch panel for receiving input from a user of the device;
a microphone;
a headphone jack;
at least one control button;
a micro USB connection;
a speaker;
a motion sensor; and
an attaching fastener.

2. The wearable digital media device of claim 1 wherein the motion sensor comprises a magnetometer and an accelerometer.

3. The wearable digital media device of claim 1 wherein the integrated circuit is a radio frequency integrated circuit.

4. The wearable digital media device of claim 1 wherein the host processing device is a personal computer.

5. The wearable digital media device of claim 1 wherein the host processing device is a tablet computer.

6. The wearable digital media device of claim 1 wherein the host processing device is a smart phone.

7. The wearable digital media device of claim 1 wherein the digital signals comprise content.

8. The wearable digital media device of claim 7 wherein the content comprises learning applications.

9. The wearable digital media device of claim 1 wherein the content comprises data sent from application software operating on a host processing device.

10. The wearable digital media device of claim 1 wherein the attaching fastener attaches the wearable digital media device to a watch band.

11. The wearable digital media device of claim 1 wherein the attaching fastener attaches the wearable digital media device to a pendant.

12. The wearable digital media device of claim 1 wherein the attaching fastener attaches the wearable digital media device to a bookmark.

13. The wearable digital media device of claim 1 wherein the attaching fastener attaches the wearable digital media device to a keychain.

14. The wearable digital media device of claim 1 wherein the attaching fastener attaches the wearable digital media device to a book bag.

15. The wearable digital media device of claim 1 further comprising:
the processor being further adapted to receive data from a host processing device transmitted in the form of digital signals to the wearable digital media device via the integrated circuit in the wearable digital media device to signal the broadcast of an audible signal with the speaker.

16. The wearable digital media device of claim 15 wherein the integrated circuit is a radio frequency integrated circuit.

17. The wearable digital media device of claim 15 wherein the integrated circuit is a BLUETOOTH transmitter integrated circuit.

18. The wearable digital media device of claim 15 wherein the content comprises mathematical questions and answers.

19. The wearable digital media device of claim 15 wherein the content comprises spelling questions and answers.

20. The wearable digital media device of claim 15 wherein the content comprises general knowledge questions and answers.

21. The wearable digital media device of claim 15 wherein the content comprises logical operations questions and answers.

22. The wearable digital media device of claim 15 wherein the content comprises a plurality of possible selections of which the user of the wearable digital media device may select one of the possible selections which is subsequently sent and received as content.

23. A system for communication between a host processing device and a personal digital media device, comprising:
a host processing device that is configured and programmed to perform actions including:
a radio frequency integrated circuit that is configured to send and receive digital signals encoding content with a personal digital media device;
a database file and file system to store and recognize a unique serial identification number corresponding to a wearable digital media device where a unique serial identification number is transmitted as digital signals by the wearable digital media device by radio frequency; and
the wearable digital media device comprising:
a radio frequency integrated circuit that is configured to send and receive digital signals encoding content with a host processing device;
a unique serial identification number; and
an attaching fastener.

24. The system of claim 23 wherein the host processing device is a personal computer.

25. The system of claim 23 wherein the host processing device is a tablet computer.

26. The system of claim 23 wherein the host processing device is a smart phone.

27. A system for communication between a host processing device and a personal digital media device, comprising:
a host processing device that is configured and programmed to perform actions including:
a radio frequency integrated circuit that is configured to send and receive digital signals encoding content with a personal digital media device;
a display screen;
a database file and file system to store and recognize a unique serial identification number corresponding to a wearable digital media device where a unique serial identification number is transmitted as digital signals by the wearable digital media device by radio frequency; and
the wearable digital media device comprising:
a radio frequency integrated circuit that is configured to send and receive digital signals encoding content with a host processing device;
a unique serial identification number;
a touch screen display;
a remote control functional mode that displays the content of the touch screen display on the display screen of the host processing device; and
an attaching fastener.

28. The system of claim 27 wherein the host processing device is a personal computer.

29. The system of claim 27 wherein the host processing device is a tablet computer.

30. The system of claim 27 wherein the host processing device is a smart phone.
